(19) United States
(12) Patent Application Publication
(10) Pub. No.: US 2019/0359138 A1
(43) Pub. Date: Nov. 28, 2019

(54) VEHICLE VISUAL RECOGNITION DEVICE

(71) Applicant: KABUSHIKI KAISHA TOKAI-RIKA-DENKI-SEISAKUSHO, Aichi (JP)

(72) Inventors: Shigeki YOSHIDA, Aichi (JP); Suguru FUJISAKI, Aichi (JP)

(21) Appl. No.: 16/477,712

(22) PCT Filed: Jan. 30, 2018
(86) PCT No.: PCT/JP2018/002985

§ 371 Date: Jul. 12, 2019

(30) Foreign Application Priority Data
Feb. 3, 2017 (JP) 2017-018703

(51) Int. Cl. B60R 1/074; B60R 1/072; B60R 16/02

(52) U.S. Cl. CPC B60R 1/074; B60R 16/0215; B60R 1/072

(57) ABSTRACT

A vehicle visual recognition device includes an operating mechanism that electrically operates a visual recognition means that assists visual recognition by an occupant of a vehicle, and a stowing mechanism that electrically stows a housing body in which the visual recognition means is housed. In this vehicle visual recognition device, wiring that is electrically connected to the operating mechanism and to the stowing mechanism is routed inside the stowing mechanism.

### TECHNICAL FIELD

The present invention relates to a vehicle visual recognition device including an operating mechanism and a stowing mechanism.

### BACKGROUND ART

A vehicle visual recognition device disclosed in Japanese Patent Application Laid-Open (JP-A) No. 2003-341427 includes a mirror face angle adjustment mechanism, this corresponding to an operating mechanism of a mirror, and a stowing mechanism. Wiring that is electrically connected to the mirror face angle adjustment mechanism extends from a lower portion to an upper portion of the stowing mechanism. Namely, there is a need to provide an opening in the stowing mechanism in order to allow the wiring inserted into the stowing mechanism to extend toward the mirror face angle adjustment mechanism. There is a possibility that liquid (such as water) might enter through this opening. Moreover, a connection location of the wiring to the mirror face angle adjustment mechanism is provided at the exterior of the mirror face angle adjustment mechanism and the stowing mechanism. Namely, since the connection portion of the wiring is exposed to the exterior, liquid (such as water) might enter the connection portion, resulting in a poor connection.

### SUMMARY OF INVENTION

### Technical Problem

In consideration of the above circumstances, an object of the present invention is to obtain a vehicle visual recognition device with improved waterproofing performance.

### Solution to Problem

A vehicle visual recognition device of a first aspect includes: an operating mechanism that electrically operates a visual recognition means that assists visual recognition by an occupant of a vehicle; and a stowing mechanism that electrically stows a housing body in which the visual recognition means is housed, wiring that is electrically connected to the operating mechanism and to the stowing mechanism is routed inside the stowing mechanism.

A vehicle visual recognition device of a second aspect is the vehicle visual recognition device of the first aspect, wherein the stowing mechanism includes a swing body that is connected to the housing body, and a support shaft that supports the swing body so as to allow swinging, and the swing body includes a covering member that covers an upper portion of the swing body and that includes a retention portion that retains the support shaft.

A vehicle visual recognition device of a third aspect is the vehicle visual recognition device of the second aspect, wherein the covering member includes an escape portion through which wiring, which has passed in an axial direction through the support shaft, is led inside the stowing mechanism.

A vehicle visual recognition device of a fourth aspect is the vehicle visual recognition device of any one of the first to the third aspects, wherein wiring that is electrically connected to the operating mechanism is connected inside the stowing mechanism.

### Advantageous Effects

In the vehicle visual recognition device of the first aspect, the wiring that is electrically connected to the operating mechanism and the stowing mechanism is routed inside the stowing mechanism. Thus, there is no need to for the wiring to lead from the stowing mechanism to the exterior, thereby improving waterproofing performance.

In the vehicle visual recognition device of the second aspect, the stowing mechanism includes the support shaft that supports the swing body connected to the housing body so as to allow swinging. In the swing body, the covering member covering the upper portion of the swing body includes the retention portion that retains the support shaft. Namely, conventionally, there was a need to provide an opening in an axial center portion of the support shaft to allow the wiring to pass through, as well as a retention member to retain the support shaft, and a covering member to cover the retention member. However, in this vehicle visual recognition device, the covering member includes the retention portion that retains the support shaft, thereby reducing the number of components.

In the vehicle visual recognition device of the third aspect, the covering member includes the escape portion, thereby enabling the wiring to be laid inside the stowing mechanism.

In the vehicle visual recognition device of the fourth aspect, the wiring that is electrically connected to the operating device is connected up inside the stowing device, thereby improving waterproofing performance.

### BRIEF DESCRIPTION OF DRAWINGS

FIG. 1 is an exploded perspective view of a vehicle door mirror device according to an exemplary embodiment of the present invention, as viewed from a vehicle rear side and vehicle width direction inside.

FIG. 2 is a cross-section of a support shaft portion of a vehicle door mirror device according to an exemplary embodiment of the present invention, as viewed from a vehicle rear side.

FIG. 3 is a cross-section of a support shaft portion of a vehicle door mirror device according to an exemplary embodiment of the present invention, as viewed from a vehicle width direction inside.

FIG. 4 is a perspective view of a stowing mechanism of a vehicle door mirror device according to an exemplary embodiment of the present invention, as viewed from a vehicle rear side and vehicle width direction inside.

FIG. 5 is a perspective view of a swing body and reinforcement of a vehicle door mirror device according to an exemplary embodiment of the present invention, as viewed from a vehicle rear side and vehicle width direction inside.

FIG. 6 is a cross-section of relevant portions of a mirror face adjustment mechanism of a vehicle door mirror device according to an exemplary embodiment of the present invention, as viewed from a vehicle width direction inside.

### DESCRIPTION OF EMBODIMENTS

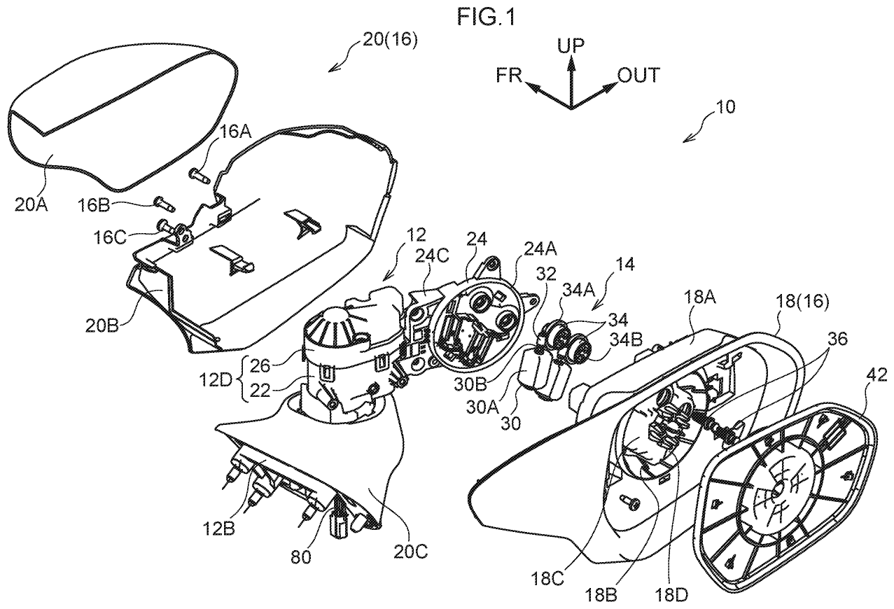

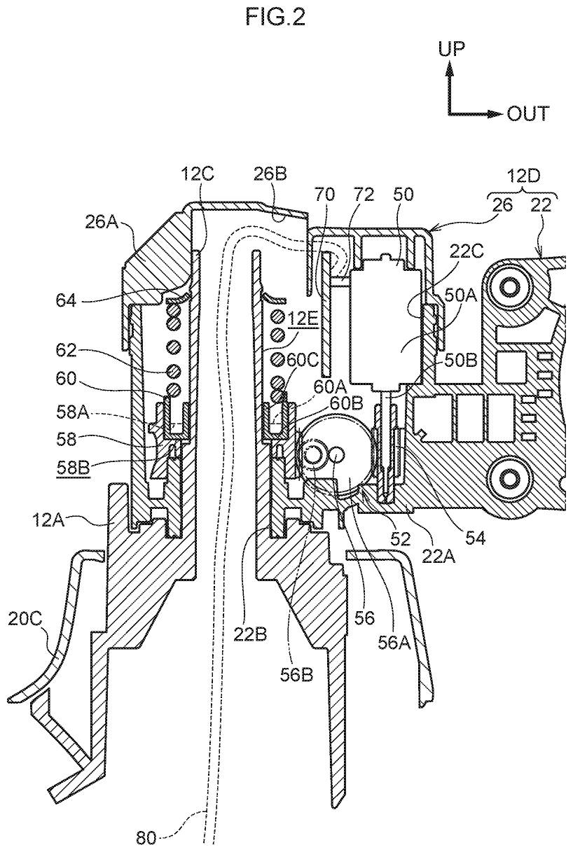

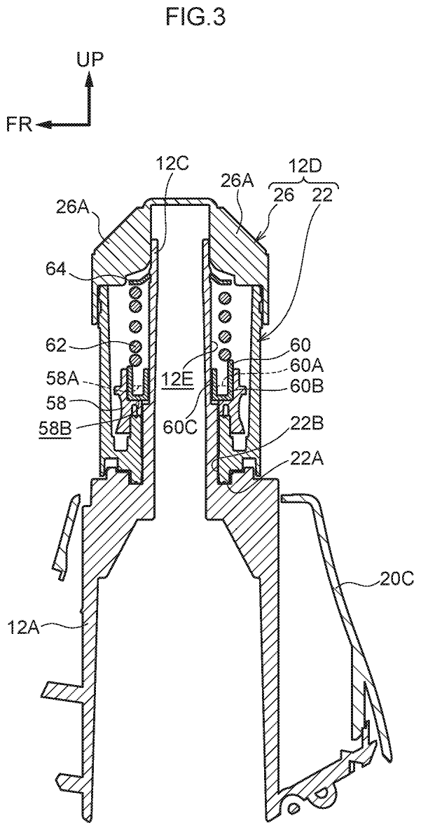

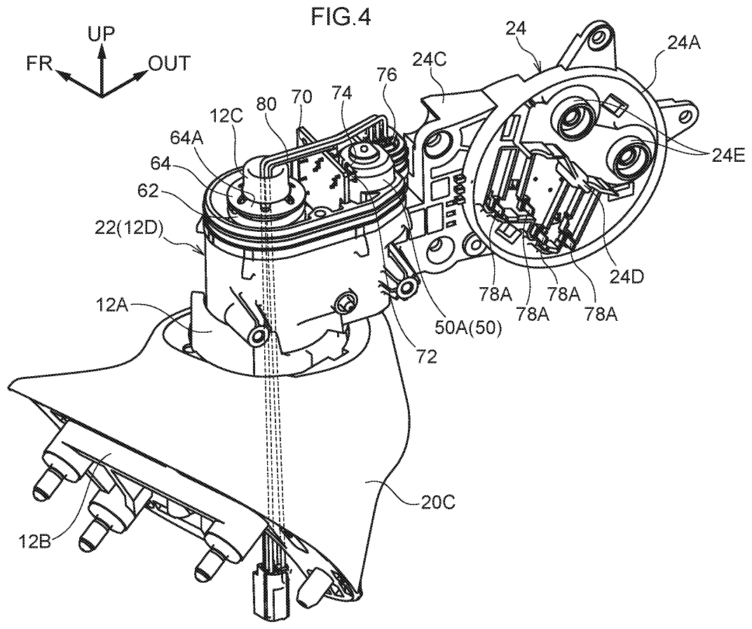

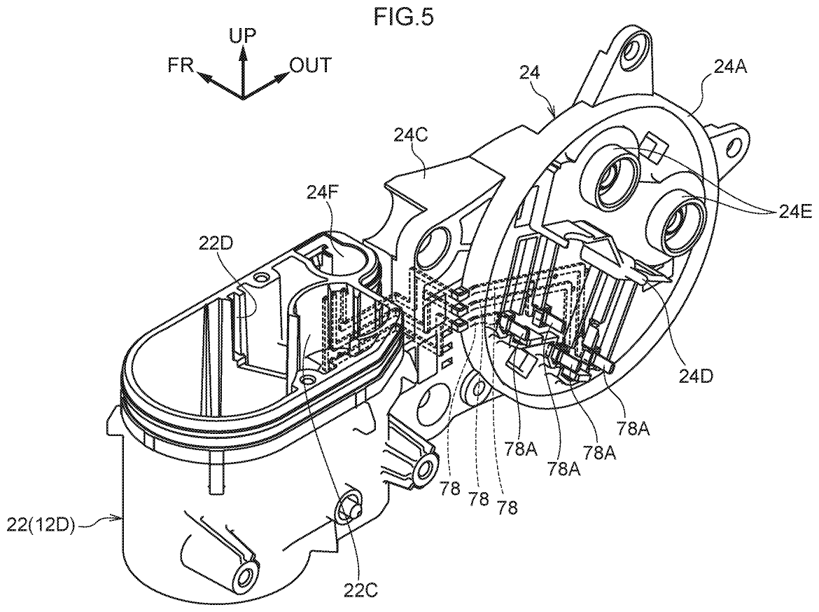

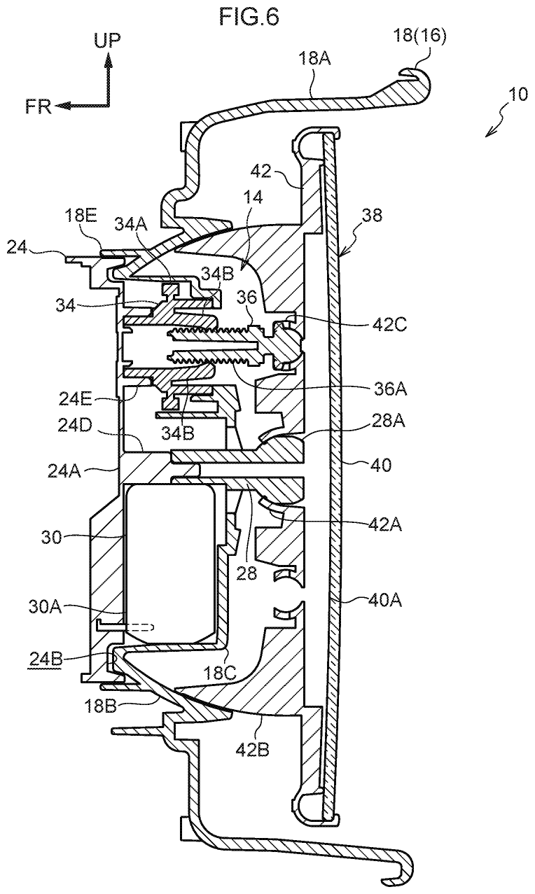

FIG. 1 is an exploded perspective view of a vehicle door mirror device 10 (vehicle visual recognition device) according to an exemplary embodiment of the present invention, as viewed from a vehicle rear side and vehicle width direction inside (vehicle left side). FIG. 2 is a cross-section of relevant portions of the vehicle door mirror device 10, as viewed from the vehicle rear side. FIG. 3 and FIG. 6 are cross-sections of relevant portions of the vehicle door mirror device 10, as viewed from the vehicle width direction inside (vehicle left side). FIG. 4 and FIG. 5 are both exploded perspective views of relevant portions of the vehicle door mirror device 10. Note that in the drawings the arrow FR indicates the vehicle front, the arrow OUT indicates the vehicle width direction outside, and the arrow UP indicates upwards.

The vehicle door mirror device 10 according to the present exemplary embodiment is supported at the outside of a door (front side door, vehicle body side) of a vehicle.

As illustrated in FIG. 1, the vehicle door mirror device 10 includes a stowing mechanism 12. As illustrated in FIG. 2 and FIG. 3, the stowing mechanism 12 is provided with a stand 12A, serving as a base member. A fixing portion 12B is provided at a lower portion of the stand 12A. The fixing portion 12B is covered by a base cover 20C (see FIG. 1). The vehicle door mirror device 10 is supported on the door by the fixing portion 12B being supported at a vehicle front side end of a vertical direction intermediate portion of the door. An integrally provided substantially circular tube shaped support shaft 12C projects upright from the upper side of the fixing portion 12B. The support shaft 12C is disposed such that its axial direction runs along the vertical direction. The support shaft 12C supports a swing body 12D, described later, such that the swing body 12D is capable of swinging. Specifically, the support shaft 12C is inserted through a through-hole 22B, described later, provided in the swing body 12D, such that the stand 12A (support shaft 12C) supports the swing body 12D such that the swing body 12D is capable of swinging. The stowing mechanism 12 is electrically operated to swing the swing body 12D about the vertical direction with respect to the stand 12A. The stowing mechanism 12 is electrically connected, through the inside of the stand 12A, to a controller (not illustrated in the drawings) on the vehicle body side, and the stowing mechanism 12 is electrically operated under the control of the controller.

As illustrated in FIG. 1, a visor 16, made from resin and serving as an outer peripheral body, is supported by the swing body 12D of the stowing mechanism 12. A visor body 18, serving as a housing body, is provided to the visor 16. The visor body 18 is fixed to the swing body 12D, for example by fastening with a first screw 16A and a second screw 16B from the vehicle front side. A curved plate shaped visor cover 20, serving as a covering member, is assembled at the vehicle front side of the visor body 18 such that reinforcement 24, integrally formed with the swing body 12D, is interposed between the visor cover 20 and the visor body 18. An outer periphery of the visor cover 20 is fitted to an outer periphery of the visor body 18, such that the visor cover 20 covers the vehicle front side of the visor body 18. An upper cover 20A is provided at an upper side of the visor cover 20, and a lower cover 20B is provided at a lower side of the visor cover 20. The visor cover 20 is configured by combining the upper cover 20A and the lower cover 20B.

As illustrated in FIG. 4 and FIG. 5, the swing body 12D includes a case 22, made of resin and serving as an accommodating member. The case 22 is open at an upper side. The circular through-hole 22B is provided in a lower wall 22A of the case 22 (see FIG. 2 and FIG. 3). A motor base 22C (assembly member) is provided at the vehicle width direction outside of the through-hole 22B (see FIG. 2 and FIG. 5).

As illustrated in FIG. 1 to FIG. 3, the swing body 12D includes a receptacle shaped cover 26, made of resin and serving as a covering member, at the upper side of the case 22. The cover 26 is open at a lower side. A lower end of the cover 26 is fixed to an outer periphery of an upper end portion of the case 22. The cover 26 covers the upper side of the case 22 so as to cover the support shaft 12C and a motor 50, described later (see FIG. 2).

As illustrated in FIG. 2 and FIG. 3, plural plate shaped ribs 26A, serving as a retention portion, are provided corresponding to an upper portion of the support shaft 12C at the inside of the cover 26 so as to point toward an axial center of the support shaft 12C. A face on the support shaft 12C side of each of the plural ribs 26A abuts the support shaft 12C, such that the ribs 26A retain the support shaft 12C. Note that a portion of the cover 26 corresponding to a gap between the ribs 26A at the vehicle width direction outside of the support shaft 12C configures a wiring route portion 26B, serving as an escape portion (see FIG. 2). Specifically, the spacing between adjacent ribs 26A at the wiring route portion 26B is set to a spacing that allows insertion of a cable 80, configuring the wiring. In this manner, the wiring route portion 26B enables the cable 80 inserted through the inside of the support shaft 12C to be led inside the stowing mechanism 12.

As illustrated in FIG. 2, the motor 50, serving as a drive means capable of outputting drive force, is provided inside the stowing mechanism 12. The motor 50 includes a substantially elliptical column shaped main body 50A. The main body 50A of the motor 50 is assembled into the motor base 22C from the upper side and fixed thereto. A metal output shaft 50B (motor shaft) extends coaxially from the main body 50A of the motor 50. The output shaft 50B is disposed with its axial direction running along the vertical direction, penetrates a bottom wall of the motor base 22C, and extends toward the lower side of the motor base 22C. The stowing mechanism 12 is operated by driving the motor 50 to rotate the output shaft 50B.

As illustrated in FIG. 4, a circuit board 70 is connected to the main body 50A of the motor 50. The cable 80 extends from the vehicle side, is inserted through the inside of the support shaft 12C, is led inside the stowing mechanism 12 through the wiring route portion 26B, and is connected to the circuit board 70. A pair of terminals 72 are provided at an upper portion of the circuit board 70. The pair of terminals 72 extend from the circuit board 70 toward the vehicle width direction outside.

A pair of terminal-insertion ports 74 are provided at an upper portion of a vehicle width direction inside face of the main body 50A of the motor 50. The pair of terminals 72 of the circuit board 70 are respectively inserted into the pair of terminal-insertion ports 74 to electrically connect the motor 50 and the circuit board 70 together. Note that the circuit board 70 is supported by being inserted into a groove 22D formed in the motor base 22C (see FIG. 5). The circuit board 70 is thereby assembled at the vehicle width direction inside of the motor 50.

As illustrated in FIG. 2, the case 22 accommodates a gear mechanism 52.

A worm gear 54, made of resin and serving as a first stage gear, is provided to the gear mechanism 52 at the lower side of the motor 50. The worm gear 54 is disposed with its axial direction running along the vertical direction, and a lower portion of the worm gear 54 is rotatably supported by the lower wall 22A of the case 22. The output shaft 50B of the motor 50 is coaxially inserted into the worm gear 54 from the upper side, such that the worm gear 54 rotates integrally with the output shaft 50B when the output shaft 50B is rotated.

A worm shaft 56, serving as an intermediate gear, is provided to the gear mechanism 52 at the vehicle width direction inside of the worm gear 54. The worm shaft 56 is disposed with its axial direction running along a horizontal direction and is rotatably supported by the case 22. A resin helical gear portion 56A is coaxially provided to one end side portion (a vehicle rear side portion) of the worm shaft 56, and a metal worm gear portion 56B is coaxially provided to another end side portion (a vehicle front side portion) of the worm shaft 56. The helical gear portion 56A meshes with the worm gear 54, such that the helical gear portion 56A and the worm gear portion 56B rotate as an integral unit when the worm gear 54 rotates, thereby rotating the worm shaft 56.

A gear plate 58 (worm wheel), made of metal and serving as a gear, is provided to the gear mechanism 52 at the vehicle width direction inside of the worm shaft 56. The gear plate 58 is a member that receives drive force from the motor 50 through the worm shaft 56 and so on at an outer peripheral face side, and is provided about the axis of the support shaft 12C. The support shaft 12C of the stand 12A coaxially penetrates the gear plate 58, and the gear plate 58 is capable of rotating about the axis of the support shaft 12C.

As illustrated in FIG. 2 and FIG. 3, a ring shaped indentation is formed in an upper face of the gear plate 58. Upper side contact faces 58A that make face-to-face contact with a clutch plate 60, described later, from the lower side, and detent recesses 58B, serving as an engaged location, are formed to an upper face of the indentation. The upper side contact faces 58A and the detent recesses 58B are formed alternately around the ring shaped upper face of the gear plate 58 (as an example, four of each are formed in the present exemplary embodiment).

The plural detent recesses 58B are disposed at uniform spacings around the circumferential direction of the gear plate 58. Each of the detent recesses 58B is formed with an inverted trapezoidal shaped profile, set such that a dimension at an upper end opening side is longer than that at a base portion side as viewed in vertical cross-section sectioned along the circumferential direction of the gear plate 58.

The clutch plate 60 is provided about the axis of the support shaft 12C at the upper side of the gear plate 58. The clutch plate 60 is formed of metal in a substantially circular tube shape. The support shaft 12C of the stand 12A coaxially penetrates the clutch plate 60. Protrusions 60C that bulge toward the radial direction inside of the clutch plate 60 and extend along the axial direction of the clutch plate 60 are formed to an inner peripheral side of the clutch plate 60. Plural of the protrusions 60C are formed at uniform spacings around the circumferential direction at an inner peripheral portion of the clutch plate 60, and fit into groove portions 12E formed in the support shaft 12C of the stand 12A. The clutch plate 60 is thereby incapable of rotating about the axis of the support shaft 12C, but is capable of moving along the axial direction of the support shaft 12C (the vertical direction).

Lower side contact faces 60A, which are normally (when external force with a high load is not acting on the visor 16 and so on) in face-to-face contact with the upper side contact faces 58A of the gear plate 58, and detent protrusions 60B, serving as engaging locations, are formed to a lower face of the clutch plate 60. The lower side contact faces 60A and the detent protrusions 60B are alternately formed around the ring shaped lower face of the clutch plate 60 (as an example, four of each are formed in the present exemplary embodiment).

The plural detent protrusions 60B are disposed at uniform spacings around the circumferential direction of the clutch plate 60. Each of the detent protrusions 60B is formed with an inverted trapezoidal shaped profile, set such that a dimension at an upper end side is longer than that at a lower end side as viewed in vertical cross-section sectioned along the circumferential direction of the clutch plate 60. The cross-section profile of the detent protrusions 60B of the clutch plate 60 is similar to, but slightly smaller than, the cross-section profile of the detent recesses 58B in the gear plate 58.

Namely, the detent protrusions 60B of the clutch plate 60 are capable of being inserted into the detent recesses 58B of the gear plate 58, and the detent recesses 58B of the gear plate 58 and the detent protrusions 60B of the clutch plate 60 are capable of engaging with each other. When the detent protrusions 60B of the clutch plate 60 are inserted into the detent recesses 58B of the gear plate 58, the lower side contact faces 60A of the clutch plate 60 are in face-to-face contact with the upper side contact faces 58A of the gear plate 58.

A coil spring 62 (compression coil spring), serving as an urging member, is provided around the axis of the support shaft 12C at the upper side of the clutch plate 60. The coil spring 62 is made of metal and is formed in a helical shape, and the support shaft 12C of the stand 12A is coaxially inserted through the inside of the coil spring 62.

A substantially annular plate shaped push nut 64 (anchor member) is provided at the upper side of the coil spring 62. The push nut 64 includes plural anchor claws 64A that are anchored to the support shaft 12C of the stand 12A, and the push nut 64 is coaxially fixed to the support shaft 12C of the stand 12A (see FIG. 4). In the state fixed to the support shaft 12C, the push nut 64 presses and compresses the coil spring 62 toward the lower side, such that the coil spring 62 urges the clutch plate 60 toward the lower side so as to contact the gear plate 58. Thus, under the urging force of the coil spring 62, the clutch plate 60 engages with the gear plate 58, the detent protrusions 60B of the clutch plate 60 are retained in a state inserted into the detent recesses 58B of the gear plate 58, and rotation of the gear plate 58 about the axis of the support shaft 12C is restricted by the clutch plate 60 and so on.

The worm gear portion 56B of the worm shaft 56 meshes with the gear plate 58. When the worm gear portion 56B is rotated, the worm gear portion 56B is swung about the gear plate 58, such that the swing body 12D swings integrally with the worm gear portion 56B with respect to the gear plate 58. Namely, when drive force from the motor 50 is received while rotation of the gear plate 58 about the support shaft 12C is being restricted, maintaining the restriction on rotation causes the drive force from the motor 50 to act as a swinging force on the swing body 12D.

As illustrated in FIG. 1 to FIG. 6, a substantially cuboid box-shaped housing wall 18A, serving as a housing section, is provided to the visor body 18. The inside of the housing wall 18A is open toward the vehicle rear side.

As illustrated in FIG. 6, a support wall 18B (case lower portion), serving as a support portion, is integrally provided to a vehicle front side wall (bottom wall) of the housing wall 18A. The support wall 18B projects out to both the vehicle front side and vehicle rear side of the vehicle front side wall of the housing wall 18A. The support wall 18B is substantially tube shaped, and is disposed such that a center axis of the support wall 18B is parallel to the vehicle front-rear direction. The support wall 18B has a spherical wall shape, with the internal diameter dimension of the support wall 18B gradually increasing on progression toward the vehicle rear.

A receptacle shaped covering wall 18C (case upper portion), serving as a covering portion, is provided at the inside of the support wall 18B. The entire periphery of a vehicle front side end of the covering wall 18C is integrated to the entire periphery of a vehicle front side end of the support wall 18B. A flat plate shaped coupling wall 18D is integrally provided between the vehicle front side end of the covering wall 18C and the vehicle front side end of the support wall 18B (see FIG. 1). The coupling wall 18D couples together the vehicle front side end of the covering wall 18C and the vehicle front side end of the support wall 18B at locations where the vehicle front side end of the covering wall 18C and the vehicle front side end of the support wall 18B are not directly integrated together. The inside of the covering wall 18C is open toward the vehicle front side of the support wall 18B. The inside of the covering wall 18C is thereby open toward the vehicle front side of the housing wall 18A.

A circular tube shaped fitting tube 18E, serving as a peripheral portion, is integrally provided to a vehicle front-rear direction intermediate portion of an outer peripheral face of the support wall 18B. The fitting tube 18E projects out from the support wall 18B toward the vehicle front side, and is disposed coaxially to the support wall 18B.

A substantially circular tube shaped retention tube 28, serving as a central support portion, is integrally provided to a vehicle rear side wall (bottom wall) of the covering wall 18C. The retention tube 28 projects out to both the vehicle front side and the vehicle rear side of the vehicle rear side wall of the covering wall 18C, and is disposed coaxially to the support wall 18B. A retention ball 28A having a substantially spherical shape is provided at a vehicle rear side end portion of the retention tube 28. A vehicle front side portion of the retention ball 28A has a spherical shaped peripheral face, with the center of the spherical face profile being aligned with the center of an inner peripheral face of the support wall 18B.

As illustrated in FIG. 1, the reinforcement 24, substantially made from resin in an elongated plate shape and serving as a placement member (reinforcement body), is provided at the vehicle front side of the visor body 18 and the stowing mechanism 12. The reinforcement 24 extends along the vehicle width direction. As illustrated in FIG. 4 and FIG. 5, the reinforcement 24 of the present exemplary embodiment is integrally formed with the case 22, and the reinforcement 24 extends from the vehicle front side of a vehicle width direction outside wall portion of the case 22 toward the vehicle width direction outside. A circular disk shaped bottom wall portion 24A, serving as a closing portion, is provided to a vehicle width direction outside portion of the reinforcement 24. A coupling portion 24C is provided between the case 22 and the bottom wall portion 24A.

The reinforcement 24 has higher rigidity than that of the visor body 18, and the reinforcement 24 reinforces the visor body 18 and the swing body 12D. Moreover, the visor cover 20 (the lower cover 20B) of the visor 16 is fixed to the reinforcement 24 by fastening with a third screw 16C. The visor cover 20 is thereby assembled to the visor body 18 such that the reinforcement 24 interposed between the visor cover 20 and the visor body 18, as described above.

As illustrated in FIG. 6, an insertion recess 24B with a rectangular cross-section profile is formed around the entire periphery of an outer peripheral portion of a vehicle rear side face of the bottom wall portion 24A. The vehicle front side end of the support wall 18B of the visor body 18 is inserted into the insertion recess 24B. The outer peripheral face of the bottom wall portion 24A fits inside the fitting tube 18E of the visor body 18, and the outer peripheral face of the support wall 18B fits together with an outer peripheral face of the insertion recess 24B. The bottom wall portion 24A thereby covers and closes off the vehicle front side of the support wall 18B, the covering wall 18C, and the coupling wall 18D of the visor body 18, and reinforces the support wall 18B, the covering wall 18C, and the coupling wall 18D.

As illustrated in FIG. 4 and FIG. 5, an insertion-fitting column 24D, with a substantially circular column shape and serving as an insertion-fitting portion, is integrally provided at a central portion of the bottom wall portion 24A. The insertion-fitting column 24D projects out from the bottom wall portion 24A toward the vehicle rear side, and is disposed coaxially to the bottom wall portion 24A. A leading end portion of the insertion-fitting column 24D has a reduced diameter. The leading end portion of the insertion-fitting column 24D is insertion-fitted inside the retention tube 28 of the visor body 18 from the vehicle front side, and thus reinforces the retention tube 28 (see FIG. 6).

Circular tube shaped support tubes 24E are integrally provided to an upper portion and a vehicle width direction outside portion of the bottom wall portion 24A. Each of the support tubes 24E projects out from the bottom wall portion 24A toward the vehicle rear side, and is disposed such that a center axis of the support tube 24E runs parallel to the center axis of the bottom wall portion 24A.

As illustrated in FIG. 5, three elongated plate shaped terminals 78, configuring wiring, are provided embedded in the reinforcement 24. The reinforcement 24 is manufactured by molding (insert molding) in a state in which the terminals 78 are disposed inside the reinforcement 24. The terminals 78 extend along the vehicle width direction, such that the terminals 78 are disposed extending from a power supply connector 24F, described below, to the bottom wall portion 24A via the coupling portion 24C.

The bottomed tube shaped power supply connector 24F, serving as a receptor portion, is integrally provided to the case 22 of the swing body 12D. A plug 76 is connected to the cable 80 that extends from the vehicle side, is inserted through the inside of the support shaft 12C, and is led through the inside of the stowing mechanism 12 through the wiring route portion 26B. The plug 76 is inserted into the power supply connector 24F, thereby connecting the wiring of the cable 80 and the terminals 78. Base end portions (vehicle width direction inside end portions) of the terminals 78 extend inside the power supply connector 24F. The base end portions of the terminals 78 are electrically connected to the controller via the inside of the swing body 12D and the inside of the stand 12A.

A leading end side portion (vehicle width direction outside portion) of one of the terminals 78 branches in two. Leading end portions of the terminals 78 (including each of the branch portions of the one terminal 78) extend from the bottom wall portion 24A toward the vehicle rear side, and configure output terminals 78A, serving as connecting portions. There are accordingly four of the output terminals 78A provided, with the output terminals 78A being provided in two pairs.

As illustrated in FIG. 6, a mirror face adjustment mechanism 14, serving as an operating mechanism, is retained between the covering wall 18C of the visor body 18 and the bottom wall portion 24A of the reinforcement 24.

A pair of motors 30, serving as another drive means, are provided to the mirror face adjustment mechanism 14. A main body 30A of each of the motors 30 is retained in a state clamped between the covering wall 18C and the bottom wall portion 24A. As illustrated in FIG. 1, an output shaft 30B extends from each of the main bodies 30A, and a worm 32, serving as an output member, is fixed to the output shaft 30B. A pair of terminal-insertion ports, not illustrated in the drawings, are provided to each of the main bodies 30A, and each pair of the output terminals 78A is inserted into the corresponding pair of terminal-insertion ports so as to electrically connect the terminals 78 and the motors 30 together. The mirror face adjustment mechanism 14 is electrically operated by supplying electrical power to the motors 30 and driving the motors 30 under the control of the controller.

As illustrated in FIG. 1 and FIG. 6, a pair of wheel drives 34, each made from resin in a substantially circular tube shape and serving as a transmission member, are provided to the mirror face adjustment mechanism 14. In a state in which a vehicle front side portion of each of the wheel drives 34 has been insertion-fitted into the corresponding support tube 24E of the bottom wall portion 24A, the wheel drives 34 are clamped between the covering wall 18C and the bottom wall portion 24A and retained so as to be capable of axial rotation.

A worm wheel 34A is formed coaxially to an outer peripheral portion of an axial direction (vehicle front-rear direction) intermediate portion of each of the wheel drives 34. Each of the worm wheels 34A is meshed (engaged) with the worm 32 of the corresponding motor 30. The worm wheels 34A are rotated by driving each of the motors 30 so as to rotate the worms 32, thereby rotating the wheel drives 34.

A predetermined number (four in the present exemplary embodiment) of meshing claws 34B, serving as engaging portions, are formed to an inner peripheral portion of each of the wheel drives 34 at the vehicle rear side of the worm wheel 34A. The predetermined number of meshing claws 34B are disposed at uniform spacings around the circumferential direction of the wheel drive 34. The meshing claws 34B extend toward the vehicle rear side and are elastic. Leading ends (vehicle rear side ends) of the meshing claws 34B project toward the radial direction inside of the respective wheel drives 34.

A substantially circular column shaped rod drive 36, serving as a moving member, is coaxially inserted inside each of the wheel drives 34. Each of the rod drives 36 projects through the covering wall 18C toward the vehicle rear side. One of the rod drives 36 is disposed above (or alternatively below) a center axis of the support wall 18B of the visor body 18. The other of the rod drives 36 is disposed at the vehicle width direction outside (or alternatively at the vehicle width direction inside) of the center axis of the support wall 18B.

As illustrated in FIG. 6, portions other than leading end portions (vehicle rear side end portions) of the rod drives 36 configure threads 36A. The leading ends of the meshing claws 34B of the wheel drives 34 are meshed (engaged) with the respective threads 36A. The leading end portions of the rod drives 36 have substantially spherical shapes.

A mirror body 38, serving as a visual recognition means, is housed inside the housing wall 18A of the visor body 18. The entire periphery and vehicle front side of the mirror body 38 is covered by the housing wall 18A.

A substantially rectangular plate shaped mirror 40, serving as a visual recognition portion, is provided at a vehicle rear side portion of the mirror body 38. A surface of the mirror 40 is exposed at the vehicle rear side of the visor body 18. A mirror face 40A of (the surface of a reflective layer on the reverse side of) the mirror 40 faces toward the vehicle rear side. The mirror 40 assists vehicle rearward visual recognition by an occupant (in particular the driver) of the vehicle.

A substantially rectangular plate shaped mirror holder 42 (see FIG. 1), made from resin, and serving as a sliding body is provided on a vehicle front side portion of the mirror body 38. The entire periphery of the mirror holder 42 fixes (retains) the entire periphery of the mirror 40 and covers the vehicle front side (reverse side) of the mirror 40.

A substantially tube shaped attachment wall 42A, serving as an attachment portion, is formed to the mirror holder 42 at a vehicle front side of a central position (center of gravity position) of the mirror 40. The attachment wall 42A is disposed coaxially to the support wall 18B of the visor body 18. The attachment wall 42A has a substantially spherical wall profile, with an inner diameter dimension of the attachment wall 42A gradually increasing on progression toward the vehicle rear. The retention ball 28A of the retention tube 28 of the visor body 18 is insertion-fitted inside the attachment wall 42A. The attachment wall 42A is thereby retained on the retention ball 28A so as to be capable of both tilting and sliding.

A substantially tube shaped sliding wall 42B, serving as a sliding portion, is integrally provided at the vehicle front side of the mirror holder 42. The sliding wall 42B is disposed coaxially to the support wall 18B of the visor body 18. The sliding wall 42B has a spherical wall profile, and an external diameter dimension of the sliding wall 42B gradually increases on progression toward the vehicle rear. An outer peripheral face of the sliding wall 42B abuts the inner peripheral face of the support wall 18B, and the sliding wall 42B is supported by the inner peripheral face of the support wall 18B so as to be capable of both tilting and sliding.

The mirror holder 42 is formed with a pair of substantially tube shaped swivel walls 42C, serving as a swivel portion, formed at the radial direction inside of the sliding wall 42B. One of the swivel walls 42C is disposed above (or alternatively below) the center axis of the support wall 18B of the visor body 18. The other of the swivel walls 42C is disposed at the vehicle width direction outside (or alternatively at the vehicle width direction inside) of the center axis of the support wall 18B. The swivel walls 42C are disposed such that their axial centers run parallel to the center axis of the support wall 18B of the visor body 18. The swivel walls 42C each have a substantially spherical wall profile, and the inner diameter dimension of each of the swivel walls 42C gradually increases on progression from the two vehicle front-rear direction end sides of the swivel wall 42C toward the vehicle front-rear direction center thereof.

The leading end portions of the rod drives 36 of the mirror face adjustment mechanism 14 are insertion-fitted into and retained at the inside of the swivel walls 42C. The swivel walls 42C are permitted to swivel with respect to the leading end portion of the respective rod drives 36, and are restricted from rotating about the axes of the rod drives 36. Thus, in the mirror face adjustment mechanism 14, as the wheel drives 34 (including the meshing claws 34B) are rotated as described above, the meshing positions of the leading ends of the meshing claws 34B with the threads 36A of the respective rod drives 36 are displaced, thereby moving (sliding) the respective rod drives 36 in the vehicle front-rear direction (axial direction).

Next, explanation follows regarding operation of the present exemplary embodiment.

In the vehicle door mirror device 10 configured as described above, when the stowing mechanism 12 is electrically operated, the motor 50 is driven and the worm shaft 56 (worm gear portion 56B) is made to swing about the gear plate 58. Namely, the swing body 12D swings with respect to the stand 12A, and the mirror body 38 (including the visor 16 (the visor body 18 and the visor cover 20), the reinforcement 24, and the mirror face adjustment mechanism 14) swing as a unit with the swing body 12D. The mirror body 38 thereby swings toward the vehicle rear side and the vehicle width direction inside, and the mirror body 38 is stowed. Moreover, the mirror body 38 is flipped out (deployed, returned) by swinging the mirror body 38 toward the vehicle front side and the vehicle width direction outside.

Moreover, when the mirror face adjustment mechanism 14 is electrically operated to drive the motors 30 and thus rotate the worms 32, the wheel drives 34 are rotated, and the rod drives 36 are moved in the vehicle front-rear direction. Thus, by tilting the mirror body 38 (the mirror 40 and the mirror holder 42) in at least one of the vertical direction or the vehicle width direction using the rod drives 36, the angle of the mirror face 40A of the mirror 40 (i.e. the visual recognition direction in which the occupant assisted by the mirror 40) is adjusted in at least one out of the vertical direction or the vehicle width direction.

The present exemplary embodiment incorporating the configuration and operation described above may be summarized in the following manner.

The vehicle door mirror device 10 of the present exemplary embodiment includes the stowing mechanism 12 and the mirror face adjustment mechanism 14. The stowing mechanism 12 is driven by the motor 50, and the mirror face adjustment mechanism 14 is driven by the two motors 30. As illustrated in FIG. 2 and FIG. 4, the cable 80 that supplies power to the motor 50 and the motors 30 extends from the vehicle body side to the stowing mechanism 12 (swing body 12D). The cable 80 includes two sets of signal wires, one set of signal wires being connected to the circuit board 70, and the other set of signal wires being connected to the plug 76. These signal wires are connected inside the cover 26 of the swing body 12D. In the stowing mechanism 12 of the present exemplary embodiment, there is no need to provide an opening in order to lead out the cable 80 for supplying power to the mirror face adjustment mechanism 14.

The motor 50 is connected to the circuit board 70 through the terminals 72 and the terminal-insertion ports 74. Thus, all wiring connections in the stowing mechanism 12 are completed at the inside of the swing body 12D, and so no wiring connection locations are present at the exterior of the stowing mechanism 12. Moreover, the motors 30 are connected to the plug 76 through the terminals 78. Thus, all wiring connections of the mirror face adjustment mechanism 14 are completed at the inside of the swing body 12D and the reinforcement 24, and so no wiring connection locations are present at the exterior of the stowing mechanism 12 and the mirror face adjustment mechanism 14.

In the vehicle door mirror device 10 of the present exemplary embodiment, there is no opening in the stowing mechanism 12 to lead out the cable 80, and there are no wiring connection locations present at the exterior of the stowing mechanism 12 and the mirror face adjustment mechanism 14, thereby enabling waterproofing performance to be improved. Moreover, the cable 80 is not present inside the visor 16, this being external to the stowing mechanism 12 and the mirror face adjustment mechanism 14, thereby enabling the cable 80 to be suppressed from hitting an inner wall of the visor 16 or the like and causing noise.

In the vehicle door mirror device 10 of the present exemplary embodiment, the ribs 26A that retain the support shaft 12C are provided at the upper portion of the support shaft 12C, this being at the inside of the cover 26. Note that in conventional vehicle visual recognition devices, there is a need to provide an opening through which a cable is led out at a portion corresponding to the axial center of a support shaft of a retention member that retains a support shaft, and there is also a need to provide a covering member to cover the retention member, including the opening. In contrast thereto, in the present exemplary embodiment, since there is no need to provide an opening through which a cable is led out, the retention portion (ribs 26A) that retain the support shaft 12C and the covering member (cover 26) can be configured as an integral unit. Namely, the number of components can be reduced. This enables a reduction in the number of assembly processes.

Furthermore, in a structure in which the retention portions (ribs 26A) and the covering member (cover 26) are configured as an integral unit as described above, the cable 80 can be routed at the inside of the stowing mechanism 12 by providing the wiring route portion 26B, though which the cable 80 can be inserted, to the cover 26.

Note that although the plural plate shaped ribs 26A, serving as a retention portion, are provided pointing toward the axial center of the support shaft 12C in the cover 26 of the present exemplary embodiment, the shape of the retention portion is not limited thereto. For example, a circular tube shaped retention portion with its axial direction running along the vertical direction may be provided at the inside of the cover 26. In such cases, the support shaft 12C is retained by abutting an inner peripheral face of the circular tube shaped retention portion against an outer peripheral face of the support shaft 12C, namely, by fitting the circular tube shaped retention portion together with the support shaft 12C. In the case of a circular tube shaped retention portion, the cable 80 can be led inside the stowing mechanism 12 by forming a notch running along the axial direction in a wall face of the retention portion so as to allow insertion of the cable 80.

Although the reinforcement 24 is integrally formed with the swing body 12D in the present exemplary embodiment, there is no limitation thereto. In cases in which the reinforcement 24 is a separate body to the swing body 12D, for example, providing an electrical join portion at a portion where the swing body 12D is fixed to the reinforcement 24 enables waterproofing to be secured. Specifically, exposed portions, namely, terminal post of the terminals 78, may be provided to the portion of the reinforcement 24 fixed to the swing body 12D, and a terminal-insertion port for this terminal post may be provided to the portion of the swing body 12D fixed to the reinforcement 24. Thus, an electrical connection would be made accompanying fixing of the reinforcement 24 to the swing body 12D, and no wiring would be present at the exterior of the stowing mechanism 12 and the mirror face adjustment mechanism 14.

Moreover, in the present exemplary embodiment, the terminals 78 provided to the reinforcement 24 are electrically connected to the mirror face adjustment mechanism 14. However, there is no limitation thereto, and a lamp (a turn lamp or a lighting lamp) may be provided to the vehicle door mirror device 10, and the terminals 78 of the reinforcement 24 electrically connected to this lamp.

Moreover, in the present exemplary embodiment, the mirror body 38 serves as a visual recognition means. However, a camera that uses imaging to assist visual recognition of an occupant may serve as the visual recognition means. In such cases the terminals 78 of the reinforcement 24 may be electrically connected to the camera.

Furthermore, in the present exemplary embodiment, the vehicle door mirror device 10 (vehicle visual recognition device) is installed at the outside of a door of a vehicle. However, the vehicle visual recognition device may be installed at another position on a vehicle.

The entire content of the disclosure of Japanese Patent Application No. 2017-018703 filed on Feb. 3, 2017 is incorporated by reference in the present specification. Explanation of the Reference Numerals
10 vehicle door mirror device (vehicle visual recognition device)
12 stowing mechanism
12C support shaft
12D swing body
14 mirror face adjustment mechanism (operating mechanism)
18 visor body (housing body)
26 cover (covering member)
26A rib (retention portion)
26B wiring route portion (escape portion)
38 mirror body (visual recognition means)
78 terminal (wiring)
80 cable (wiring)

1. A vehicle visual recognition device comprising:
an operating mechanism that electrically operates a visual recognition means that assists visual recognition by an occupant of a vehicle;
a stowing mechanism that electrically stows a housing body in which the visual recognition means is housed, and
wiring that is electrically connected to the operating mechanism and to the stowing mechanism,
a part of the wiring that has been led into the stowing mechanism and extends as far as the operating mechanism being routed inside the stowing mechanism.

2. The vehicle visual recognition device of claim 1, wherein:
the stowing mechanism includes:
a swing body that is connected to the housing body, and
a support shaft that supports the swing body so as to allow swinging; and
the swing body includes:
a covering member that covers an upper portion of the swing body and that includes a retention portion that retains the support shaft.

3. The vehicle visual recognition device of claim 2, wherein:
the swing body includes an accommodating member that is covered by the covering member; and
a lower end of the covering member is fixed to an outer periphery of an upper end portion of the accommodating member.

4. The vehicle visual recognition device of claim 3, wherein:
a placement member, at which the operating mechanism is disposed, is provided to the stowing mechanism; and
the placement member is integrally formed with the accommodating member.

5. The vehicle visual recognition device of claim 4, wherein part of the wiring is embedded in the placement member.

6. The vehicle visual recognition device of claim 2, wherein:
the stowing mechanism includes a drive means that causes the swing body to swing; and
the covering member covers an upper portion of the drive means and the swing body.

7. The vehicle visual recognition device of claim 2, wherein the covering member includes an escape portion through which wiring, which has passed in an axial direction through the support shaft, is led inside the stowing mechanism.

8. The vehicle visual recognition device of claim 1, wherein wiring that is electrically connected to the operating mechanism is connected inside the stowing mechanism.
